(19) United States
(12) Patent Application Publication
(10) Pub. No.: US 2018/0255800 A1
(43) Pub. Date: Sep. 13, 2018

(54) COMPOSITIONS AND METHODS FOR IMPROVING CHEESE PERFORMANCE

(71) Applicant: SFC Global Supply Chain, Inc., Marshall, MN (US)

(72) Inventors: Rongxuan Cai, Sioux Falls, SD (US); Bonita M. Hinze, Marshall, MN (US)

(21) Appl. No.: 15/906,121

(22) Filed: Feb. 27, 2018

Related U.S. Application Data
(60) Provisional application No. 62/463,989, filed on Feb. 27, 2017.

(51) Int. Cl. A23C 19/10; A23C 19/093; A23C 19/082; A23C 19/055; A23C 19/05

(52) U.S. Cl. CPC A23C 19/105; A23C 19/093; A23C 19/082; A23C 19/055; A23C 19/054; A23V 2250/548; A23V 2250/1578; A23V 2250/16; A23V 2250/1634; A23V 2250/54246; A23V 2250/54252; A23V 2002/00

(57) ABSTRACT

A method for stabilizing cheese proteins includes preparing a cheese mass comprising cheese curds and whey; adding a stabilizing additive to the cheese mass; straining the cheese mass to separate a cheese curd and whey; and forming the cheese curd into a cheese comprising about 18 to about 35% protein. In some embodiments, the method is modified to allow for a gentler cheese manufacturing process. A cheese composition may include cheese; about 18 to about 35% protein comprising about 0.01 to about 25% of intact protein segments by weight of the protein; and about 0.001 to about 5% of a stabilizing additive.

### CROSS REFERENCE TO RELATED APPLICATION

This application claims the benefit of U.S. Provisional Application No. 62/463,989, filed Feb. 27, 2017, which is hereby incorporated by reference in its entirety.

### FIELD

The present disclosure relates to compositions and methods for improving cheese performance including extending the shelf life of cheese that has been heated, such as baked or cooked. In some embodiments, the present disclosure relates to compositions and methods for extending the shelf life of cheese that has been baked or cooked and is maintained at an elevated temperature for serving or display.

### BACKGROUND

Cheese has been made and enjoyed by humans since ancient times. The basic cheese making process using rennet for coagulation is speculated to have been accidentally discovered by nomads using sheep and goat stomachs to store milk. Cheese is typically made by allowing milk to ferment either by adding a culture to the milk or by allowing wild bacteria to grow in the milk. After lactic acid develops in the milk culture, rennet or an acid is added to cause coagulation of casein proteins to produce cheese curds. The remaining liquid, whey, is strained, and the curds are heated or scalded. The cheese can be allowed to mature or ripen, or can be used fresh. Variations in the basic process produce different types of cheeses.

Benchmarks of a “good cheese” can be subjective and include things like flavor, texture, mouthfeel, handling or workability (how the cheese cuts or shreds), how the cheese melts, and appearance. Desirable flavor, texture, and mouthfeel are necessary features for any cheese. Handling and workability are important properties to restaurants and manufacturers that desire a cheese that cuts or shreds nicely without breaking down into fine pieces. The melting properties of the cheese are important. In some cheese, it may be desirable for the cheese to substantially retain its shape when exposed to heat. In other cheese, it may be desirable for the cheese to lose its shape when exposed to heat and melt into a soft, stretchy texture. The melting properties of the cheese may be referred to as cheese fuse or knit. Melted or baked cheese has a soft and stretchy texture that is often desired by consumers. Baked cheese-topped foods, such as pizzas or pizza slices, can be displayed for purchase under a heat lamp and/or on a hotplate or in a heated chamber to keep the foods warm. However, when baked or melted cheese is maintained at an elevated temperature, the texture and appearance of the baked or melted cheese deteriorates fast. The texture of the cheese can become gummy, and the appearance translucent within about 10 minutes.

It is against this background that the present disclosure is made.

### SUMMARY

The present disclosure relates to compositions and methods for improving the properties of the cheese including but not limited to the shredding ability, improved stretchiness of the melted cheese, and extending the shelf life of cheese that has been heated, such as baked or cooked. The disclosed cheese may include intact protein segments that act to impart these improved properties. A method for stabilizing cheese proteins includes preparing a cheese mass comprising cheese curds and whey; adding a stabilizing additive to the cheese mass; straining the cheese mass to separate a cheese curd and whey; and forming the cheese curd into a cheese comprising about 18 to about 35% protein. A cheese composition may include cheese; about 18 to about 35% protein comprising about 0.01 to about 25% of intact protein segments by weight of the protein; and about 0.001 to about 5% of a stabilizing additive.

### BRIEF DESCRIPTION OF DRAWINGS

FIG. 1 shows a thermogram of a sample according to an embodiment and a control in Example 2.

FIG. 2A shows a thermogram of a control according to an embodiment in Example 3.

FIG. 2B shows a thermogram of a sample in Example 3.

FIGS. 2C and 2D are graphical representations of data from Example 3.

FIG. 3A shows a thermogram of a sample according to an embodiment in Example 4.

FIGS. 3B and 3C are graphical representations of data from Example 4.

FIGS. 4A and 4B are graphical representations of data from Example 5.

FIGS. 5A and 5B are graphical representations of data from Example 6.

### DETAILED DESCRIPTION

The present disclosure relates to compositions and methods for improving the properties of the cheese including but not limited to the shredding ability, improved stretchiness of melted cheese, and extending the shelf life of cheese that has been heated, such as baked or cooked.

In some embodiments, the present disclosure relates to compositions and methods for extending the shelf life of cheese that has been heated, such as baked or cooked. In particular, the present disclosure relates to compositions and method for extending the shelf life of cheese that has been baked or cooked and is maintained at an elevated temperature, such as under a heat lamp, or at room temperature.

The term “cheese” is used here to refer to natural cheeses and processed cheeses (“process cheese”) as defined by the U.S. Food and Drug Administration under 21 C.F.R. § 133. Natural cheeses are understood to include mozzarella, semi-soft cheeses, medium-hard cheeses, semi-hard cheeses, and hard cheeses. The cheese can be made from any type of milk, including cow milk, sheep milk, goat milk, buffalo milk, and the like.

The terms “processed cheese” or “process cheese” are used to refer to a product made from natural cheese and other ingredients as defined by the U.S. Food and Drug Administration under various sub-sections of 21 C.F.R. § 133 that include the label “process cheese.”

The term “native protein” is used here to refer to a protein in an unaltered state with its primary, secondary, and tertiary (and optionally quaternary, if any) structure intact.

The term “protein denaturation” is used here to refer to the process of altering at least a portion of the secondary and/or tertiary (and optionally quaternary) structures of the protein, leaving the primary structure intact. On the quaternary level, protein denaturation may involve dissociation and rearrangement of protein subunits. On the tertiary level, protein denaturation may involve disruption of covalent interactions between amino acid side chains, and of non-covalent interactions, such as dipole-dipole interactions and Van der Waals interactions. On the secondary level, protein denaturation may involve loss of repeating patterns and a resulting random configuration. Proteins can be fully or partially denatured.

Thermal denaturation properties of proteins can be analyzed using various techniques, including differential scanning calorimetry (DSC). Structural rearrangement of proteins at the denaturation temperature results in the absorption of heat caused by redistribution of non-covalent bonds. A native or intact protein will exhibit a peak in a thermogram at its denaturation temperature, while a protein that has broken down or been already denatured will not. Therefore, DSC can also be used to detect the absence or presence of native or intact proteins.

The term “intact protein” is used here to refer to proteins that have not been denatured or have not been fully denatured. Intact proteins may have undergone some degree of denaturation but have enough of the native protein's secondary, tertiary, and/or quaternary structure left that they exhibit a protein peak on a DSC scan.

The term “elevated temperature” as used with regard to maintaining a baked or cooked cheese at an elevated temperature is understood to mean a temperature of about 100 to about 210° F. (about 38 to about 99° C.).

The term “cooked shelf life” is used here to refer to the shelf life of a food when maintained at an elevated temperature. Generally, shelf life can be calculated as the time from preparation until the quality of the food has deteriorated so that the food is no longer suitable for human consumption or is no longer desirable to consumers. In this disclosure, cooked shelf life is calculated as the time from end of preparation until the appearance, flavor, texture, and/or microbial quality of the food (whichever deteriorates first) have deteriorated beyond a point that the food no longer is acceptable to consumers.

The term “gummy texture” is used here to refer to texture that is plastic and easily deformed or broken, similar to a starch-based gel or gum. A cheese with gummy texture lacks elasticity, resilience, and stretchability.

The term “translucent” is used here to refer to a physical property of a material, where a translucent object allows some light to pass through, while some light is scattered (diffused) and some light may be reflected. In contrast, transparent material allows light to pass through without significant scattering or reflection, thus appearing clear, and opaque material does not let any light to pass through. Examples of translucent, transparent, and opaque materials are frosted glass, clear glass, and metal, respectively.

The term “about” is used here in conjunction with numeric values to include normal variations in measurements as expected by persons skilled in the art, and is understood to have the same meaning as “approximately” and to cover a typical margin of error, such as +5% of the stated value.

As used herein, “weight percent,” “wt-%,” “percent by weight,” “% by weight,” and variations of the same refer to the concentration of a substance as the weight of the substance relative to the total weight of the composition. The terms “percent” and “%” are intended to be synonymous with “weight percent” and “wt-%” unless specifically otherwise indicated.

The cheese-making process typically begins by adding a bacterial culture to milk and allowing the milk to ferment to develop lactic acid and, depending on the culture, various other compounds, such as carbon dioxide, alcohol, aldehydes and ketones. After sufficient fermentation to develop a desired flavor profile, the cheese curd is produced by causing coagulation of casein. Coagulation can be brought on by adding enzymes (e.g., rennet, a complex of enzymes traditionally extracted from the stomach lining of young calves) or an acid to the culture. The enzymes destabilize the casein by breaking down the casein molecules such that the hydrophobic interactions overcome the hydrophilic interactions and cause the proteins to coagulate. Acid-set gelation functions by bringing pH of the system near the protein's isoelectric point and coagulating the cheese proteins. The cheese mass (mixture of cheese curds and whey) is heated (scalded) and the cheese curds are separated from the whey. The cheese curds can be separated from the whey by various methods, including draining (either during or after cooking), filtration, centrifugation, precipitation, etc. The separated cheese curds can be tempered, formed into cheese, allowed to mature, ripen, and/or age to develop a desired flavor and texture. In making mozzarella cheese, the cheese curd is cooked and stretched resulting in a more stringy cheese that can be used, for example, as a topping on pizza and other products. Enzymatic aging can be used to further develop certain flavor characteristics, for example, in the making of blue cheese.

Degradation of milk proteins and formation of protein segments which coagulate and form the cheese curd are key characteristics of cheese making. When cheese is made, it goes through process steps involving heat treatment and at least a partial breakdown of proteins. Therefore, the thermal properties of proteins in cheese are different from native proteins. For example, a typical tempering, stretching, and cooking temperature in the making of mozzarella is about 160° F. (about 71° C.). Typically, cheese that has been heated to a temperature of about 160° F. during or after its making does not exhibit a protein peak in a DSC thermogram. It is due in part to the fact that at 70° C., whey proteins begin to irreversibly denature. At temperatures above 70° C., hydrogen and hydrophobic bonds are broken and weakened, resulting in a loss of secondary and tertiary protein structures. Further, the thermal stability of the proteins in cheese is lower than that of native casein, and the proteins are easily further denatured during processing (e.g., during baking).

When cheese is heated, e.g., during baking or cooking, the proteins in the cheese are further denatured, which can shorten the cooked shelf life of the cheese. While freshly melted cheese has an attractive and appetizing appearance, taste, and texture, the cheese quickly loses this appearance when the cheese is maintained at an elevated temperature. For example, the texture of the cheese can become gummy, and the appearance translucent within about 10 to about 40 minutes at a temperature of about 120 to about 170° F. The deterioration process can be slower at lower temperatures, e.g., at room temperature.

In certain food service establishments, such as cafeterias, cafes, restaurants, service stations, convenience stores, etc., baked cheese-topped foods, such as pizzas or pizza slices, are displayed under a heat lamp, on a hotplate, and/or in a heated chamber to keep the foods warm. However, the appearance of the baked or melted cheese on top of the food deteriorates fast. The cheese may also deteriorate at room temperature, although the process may be slower. While the foods are still safe to eat, they can become unattractive to consumers much faster than the microbial quality of the food deteriorates.

According to an aspect of the present disclosure, the deterioration of baked cheese can be deterred or slowed down. In some aspects, deterioration of the cheese can be slowed down from about 10 minutes to about 75 minutes, about 20 to about 60 minutes, or about 25 to about 45 minutes. For example, when a cheese composition according to the present disclosure is used as a topping on food that is baked and then held at an elevated temperature, the cheese will not develop a translucent appearance and/or gummy texture until at least 15 minutes, at least 20 minutes, at least 25 minutes, or at least 30 minutes. The elevated temperature may be from about 100 to about 200° F., from about 120 to about 170° F., or from about 130 to about 160° F.

Without wishing to be bound by theory, it is hypothesized that certain additives or process steps act to stabilize the proteins in the cheese and prevent or slow down heat denaturation at the temperatures typically used for processing and baking. As a result, the cheese contains a higher amount of intact proteins than a cheese without the treatment, resulting in an extended warm shelf life after the cheese has been cooked. The higher amount of intact proteins may also improve cheese properties like the shredding ability of the cheese resulting in fewer small pieces known as “fines,” and the ability of the cheese to stretch when melted.

The methods and compositions of the present disclosure can be used with any type of cheese. In some embodiments, the methods and compositions are used with natural cheeses. In alternative embodiments, the compositions may include a processed cheese. Natural cheeses are made directly from milk by a process that includes fermentation, coagulation, straining, and some optional additional steps, such as heating, stretching, etc. In contrast, processed cheeses are made from natural cheese as a starting material, adding emulsifiers and/or other additives, and by heating and blending. Natural cheeses include, but are not limited to, mozzarella, provolone, cheddar, asiago, parmesan, romano, monterey Jack, gouda, Swiss (emmentaler), colby, edam, farmers, fontina, havarti, muenster, etc.

The methods and compositions of the present disclosure can be used to improve the appearance of melted cheese on a variety of food products including but not limited to pizzas (e.g., cracker, flatbread, thin crust, deep dish, hand tossed, New York, and Neapolitan), French bread pizzas, garlic bread, cheese bread, cheeseburgers, nachos, quesadillas, tacos, “loaded” potatoes or French fries, and products enrobed or stuffed with cheese.

According to an embodiment, the cooked shelf life of the cheese is extended by including an additive in the cheese. The additive may be an oxide, a salt, or a stabilizer. The additive can be selected such that the additive stabilizes the protein, preventing or reducing further denaturation during heating. Examples of suitable additives include: titanium dioxide; calcium salts such as calcium chloride, calcium citrate, calcium sulfite, calcium sulfate, calcium caseinate, and calcium propionate; potassium salts such as potassium sorbate, and potassium bitartrate (cream of tartar); sodium salts such as sodium chloride, and sodium caseinate; and protein additives such as casein, micellar casein, whey protein, and vegetable protein. The additive can be included at about 0.001 to about 5%, about 0.005 to about 4%, or about 0.01 to about 2% by wet weight of the curd. In one example, the additive is titanium dioxide and is included in the cheese at 0.1 to 0.3% of the cheese curd before cooking and stretching.

The additive may be added to the cheese during its making. For example, the additive can be added and mixed in at any time during the cheese making process before the forming of the cheese (e.g., forming into a block), such as before or during fermentation, before or during coagulation, or before or during scalding. In one embodiment, the additive is mixed in immediately prior to, during, or after coagulation. For example, the additive can be mixed in after coagulation and prior to scalding. In some embodiments, one or more additives can be added, and/or the additive or additives can be added at more than one stage of the cheese making process.

In one exemplary embodiment, one or more additives are added to mozzarella cheese in the last step of cheese making, i.e., before the mozzarella is cooked and stretched. For example, about 0.1 to about 0.5% or titanium dioxide may be added to stabilize the proteins and to prevent excessive denaturation and breakdown during cooking and stretching. A protein additive can also be added to provide an added intact protein that can remain in the cheese after cooking, stretching, and subsequent heating steps. Examples of suitable protein additives include casein, whey protein, and vegetable proteins. The additives function to extend the cooked shelf life of the cheese due to the intact protein fractions in the cheese.

The cheese composition may include at least 90%, at least 95%, at least 97%, at least 98%, at least 99%, or at least 99.5% natural cheese. In some embodiments the cheese composition comprises natural cheese and is free of processed cheese. In an alternative embodiment, the cheese composition comprises processed cheese.

In at least some embodiments, the cheese composition has a protein content of about 18 to about 35% (measured as nitrogen and converted to a protein value by a calculation), where at least a portion of the protein is intact protein. In at least some embodiments, the cheese composition has an additive content of about 0.001 to about 5%, about 0.005 to about 4%, about 0.001 to about 3%, about 0.1 to about 2%.

The amount of intact protein of the total protein content can be from about 0.01 to about 25%, about 1 to about 20%, or about 4 to about 18%, or about 6 to about 18%. The percentage of intact protein can be determined by calculating as follows:

$$percent intact protein = ( 1 - ( \frac{Δ H ( Reference ) - Δ H ( treatment )}{Δ H ( Reference )} ) ) * 100$$

where ΔH is the protein denaturation enthalpy as determined using DSC. The Reference used to calculate the intact protein in this disclosure is a nonfat dry milk powder (NFDM) commercially available from Dairy America, Product Number 02110-50, grade A, low heat. This Reference NFDM powder contained 31-35% protein, includes lactose, milk proteins, and milk minerals in the same relative proportions as they occur in fresh milk, and had a ΔH(Reference) of 4.85 J/g as determined using DSC.

The amount of fat in the cheese composition will mainly depend on the type of cheese prepared. For example, if mozzarella is used, the cheese composition may have a fat content of at least about 30% (part skim mozzarella), or at least about 45% (mozzarella and low moisture mozzarella) on a dry weight basis.

In an alternative embodiment, the cheese manufacturing process includes method steps that maintain a higher percentage of intact proteins in the cheese. In a typical cheese making process, the temperature of the cheese mass during separation of the curds from whey and subsequent scalding can be about 102 to about 110° F. Other parts of the cheese making process may also be altered. For example, in the case of mozzarella, which is stretched during manufacturing to induce a stringy texture, the cheese can be processed more gently. In a typical mozzarella making process, the separated cheese curd is stretched until smooth and free of lumps for about 10 to about 30 minutes at a temperature of about 150 to about 170° F. According to an embodiment, mozzarella cheese is made by limiting the stretching temperature to about 100 to about 140° F., about 100 to about 130° F., or about 100 to about 120° F. The cheese at the lower temperature may be stiffer, thus requiring a higher energy input for stretching. However, the lower temperature will have a more significant impact of preserving intact protein segments than the higher energy of the stretching. In some embodiments, the energy used for stretching can be reduced resulting in gentler stretching of the cheese. In some embodiments, the cooked shelf life of the cheese may be extended by adjusting the pH of the cheese in the vat to 4.5 to 4.8, which is near the isoelectric point of the proteins in the cheese. In some embodiments, the concentration of the starter culture can also be increased.

The thermal properties of treated cheese according to embodiments are different from thermal properties of untreated cheese. For example, the treated cheese may contain a higher percentage of intact proteins, and may exhibit a protein peak on a DSC thermogram. After having been baked or heated, the treated cheese may also have a longer cooked shelf life before appearing translucent than untreated cheese (e.g., the treated cheese may appear more white for a longer period of time when compared to an untreated cheese at a similar temperature, such as at an elevated temperature, or at room temperature) and/or developing a gummy texture.

In some embodiments, the cooked shelf life of the heated (e.g., baked) treated cheese is about 15 to about 75 minutes, about 20 to about 60 minutes, or to about 25 to about 45 minutes. For example, when a cheese composition according to the present disclosure is used as a topping on food that is baked and then held at an elevated temperature, the cheese will not develop a translucent appearance and/or gummy texture until at least 15 minutes, at least 20 minutes, at least 25 minutes, at least 30 minutes, or at least 45 minutes. If the baked food is held at room temperature, the deterioration may be slower, and the cheese may not develop a translucent appearance and/or gummy texture until at least 30 minutes, or at least 60 minutes.

In some embodiments, the color of the melted cheese does not change over time as fast as cheese that has either not been treated or not subjected to a modified manufacturing process. Accordingly, in some embodiments, cheese that has been manufactured with the additives or the modified manufacturing process has a color change (ΔL-value), as measured by a Minolta colorimeter, of less than 3 units, less than 5 units, or less than 10 units during the first 70 minutes following removal of the food product from either cooking or baking and held at a temperature of 160° F.

### EXAMPLES

### Example 1

The cooked shelf life of mozzarella cheese, treated with titanium dioxide and used as a topping on a 14-inch pizza, was tested. The treated sample was prepared by mixing 0.2 wt-% titanium dioxide in mozzarella cheese curd prior to cooking and stretching of the curd and forming the curd into cheese. A control was prepared with regular mozzarella cheese without the additive.

Each of the cheeses were grated and used to top a 14″ pizza. The pizzas were baked at 375° C. for 13-17 min using an impinging oven, until the cheeses were melted and the crust edge was golden brown. After baking, the pizzas were placed on a hotplate and maintained at 80-100° F. in a warming chamber. The appearance of the cheese was monitored over a period of 60 min.

It was found that the appearance of the regular mozzarella cheese changed from a fresh, white, melted and stringy cheese to translucent and gum-like after 10 minutes at the elevated temperature. In contrast, the appearance of the cheese treated with 0.2% TiO₂ lasted for 40 min without becoming translucent or gum-like. It was concluded that the cheese treated with TiO₂ had a much longer cooked shelf life than the regular cheese.

### Example 2

The thermal properties of mozzarella cheese treated with 0.2% titanium dioxide were tested and compared to a control of regular mozzarella cheese using a differential scanning calorimeter (“DSC”). Samples of about 45 mg were placed in the DSC and scanned at a rate of 5° C./min from 0 to 100° C. The thermograms were recorded and compared.

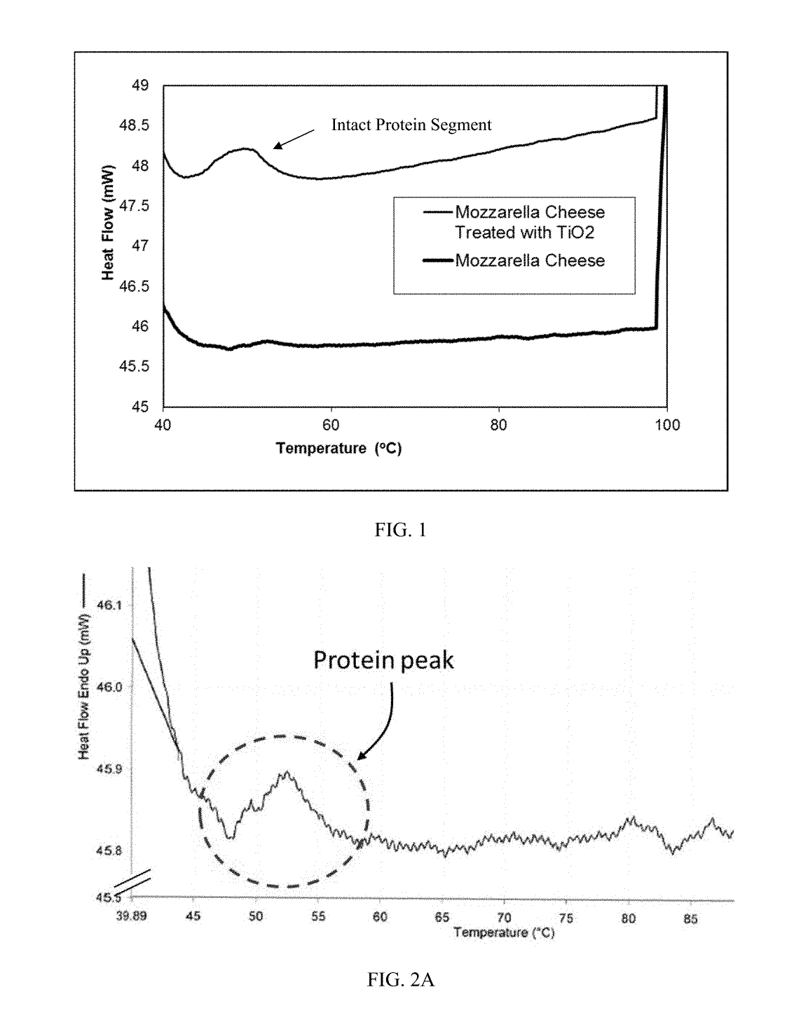

The thermograms of the treated cheese and the control are overlaid and shown in FIG. 1. The DSC peaks and their enthalpies are also shown in TABLE 1. It was observed that the control did not exhibit any peaks in the temperature range from 40° C. to 100° C., whereas the treated cheese had a protein peak at about 49.0° C.

It was concluded that treating the cheese with TiO₂ preserved an intact protein segment in the cheese that was not present in the regular cheese. The intact protein segments may contribute to the extended cooked shelf life of the cheese, because they have a capacity to form a protein network through protein unfolding during baking, thus slowing or preventing the formation of a translucent gum-like texture and appearance. It was also concluded that breakdown of intact proteins through excessive denaturation, heat decomposition, or enzymatic action caused a loss of the white, opaque, and stringy appearance and texture of the freshly baked cheese.

TABLE 1
DSC peaks in treated mozzarella cheese and control.

| | Ice | | Fat I | | Fat II | | Protein | |
|---|---|---|---|---|---|---|---|---|
| | Peak | | Peak | | Peak | | Peak | |
| | Temp | ΔH | Temp | ΔH | Temp | ΔH | Temp | ΔH |
| | (° C.) | (J/g) | (° C.) | (J/g) | (° C.) | (J/g) | (° C.) | (J/g) |
| Treated | 0.85 | 159.75 | 16.73 | 3.54 | 33.06 | 5.64 | 49.52 | 0.64 |
| Cheese | | | | | | | | |
| Control | 0.88 | 160.06 | 16.68 | 3.52 | 32.09 | 7.08 | 52.39 | 0.09 |

The column headings indicate peaks caused by different components of the samples.

### Example 3

The thermal properties and cooked shelf life of cheese treated with TiO₂ were studied and compared to a control. The treated cheese and the control were studied before and after baking and during holding at an elevated temperature.

The treated sample of mozzarella cheese was prepared by adding 0.2% TiO₂ to the cheese curd during cheese making, before stretching. The control was regular mozzarella.

The cheeses were stored in a refrigerator and taken out to room temperature just before testing. The cheeses were shredded using a 4.5 mm shredder. Twenty three grams of each of the shredded cheeses were placed onto a marked circle with a 3.5″ diameter on a baking sheet in a baking pan. Color readings were taken for each cheese before baking. The cheeses were baked in a preheated conventional oven at 450° F. for 4 min. After the baking, the cheeses were observed to have spread about 1.5″. The baked cheeses were then removed from the oven and transferred into a temperature-controlled cabin at 160° F. for a holding test to simulate food service display conditions. The product temperature in the cabin was measured at 135° F. During the holding period, color readings were taken at 10-30 min intervals over a 60 min period.

Both samples were prepared and tested in triplicate. The treated sample and the control were observed for color changes before and after baking, and during holding by monitoring the whiteness (L-value on a “L, a, b” scale) using a Minolta colorimeter (available form Konica Minolta Sensing, Inc. Ramsey, N.J.). The “a” values indicate the amount of green (−a) to red (+a), and the “b” values indicate the amount of blue (−b) to yellow (+b). Delta E (ΔE) is a calculated value that represents total color difference.

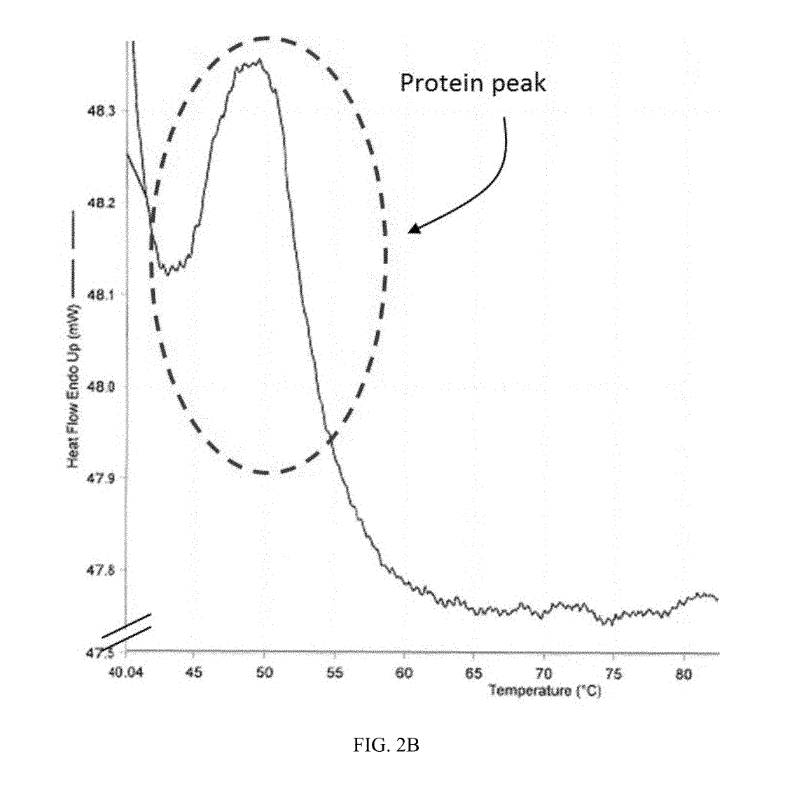

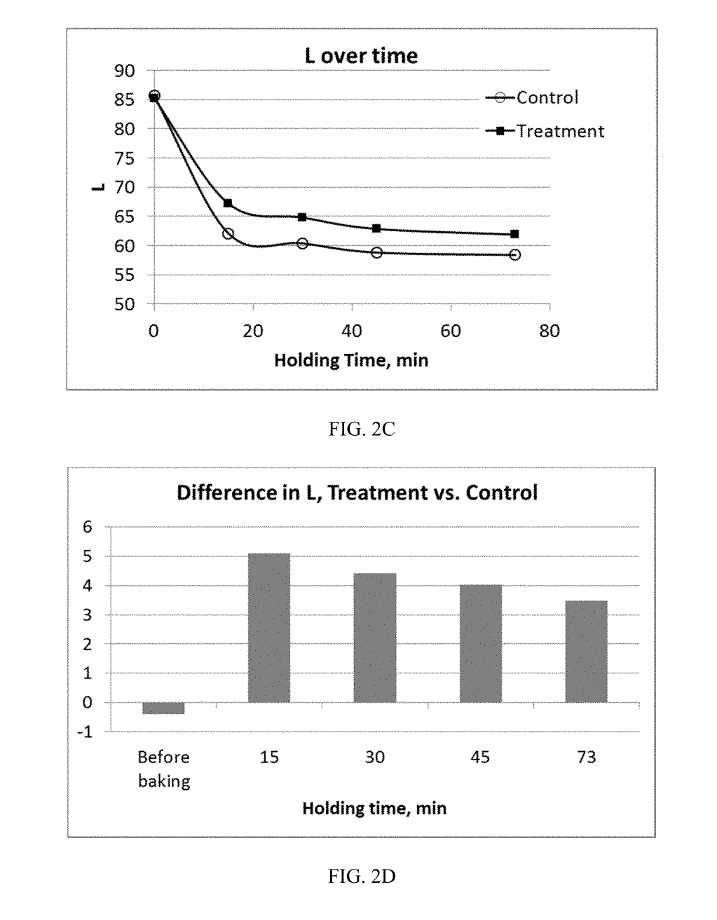

Thermograms of the control and the treated cheese are shown in FIGS. 2A and 2B, respectively. Results of the color readings are given in TABLE 2 and shown graphically in FIG. 2C. The difference in L-values is shown graphically in FIG. 2D. It was observed that at the beginning, the control cheese had a similar whiteness value as the treated cheese (L value of 85.62 vs. 85.21, respectively). Both cheese samples had similar a and b values. However, the control cheese had lower whiteness value (L value) throughout of the holding period of 73 min.

TABLE 2
Color of treated cheese and control, averages of triplicate samples.

| | | | | | Treated Cheese | | | |
|---|---|---|---|---|---|---|---|---|
| | Control | | | | with 0.2% TiO₂ | | | |
| Color | L | a | b | ΔE | L | a | b | ΔE |
| | Before baking | | | | | | | |
| | 85.62 | −1.70 | 18.70 | 20.28 | 85.21 | −4.99 | 17.99 | 19.92 |
| Holding Time | | | | | | | | |
| (min) | After Baking and During Holding | | | | | | | |
| 15 | 62.09 | −2.83 | 11.72 | 36.16 | 67.20 | −3.69 | 11.71 | 28.00 |
| 30 | 60.39 | −2.69 | 11.90 | 37.83 | 64.80 | −3.27 | 11.70 | 33.58 |
| 45 | 58.81 | −2.36 | 12.06 | 39.39 | 62.85 | −2.95 | 11.64 | 35.41 |
| 73 | 58.38 | −2.48 | 12.22 | 39.84 | 61.87 | −2.63 | 12.07 | 36.44 |

It was concluded that the treated cheese, which had a higher whiteness value and exhibited a larger protein peak, included an intact protein component. The lower ΔE of the treated cheese was attributed to the higher amount of white.

### Example 4

A treated cheese sample was prepared with gentler stretching conditions (without stretching or breakdown to the same extent as the control) during the cheese making process. The thermal properties and color changes before and after baking of the treated sample were tested and compared to a control of regular mozzarella cheese. The testing was performed as in Example 3. After the baking, the cheeses were observed to have spread about 1″.

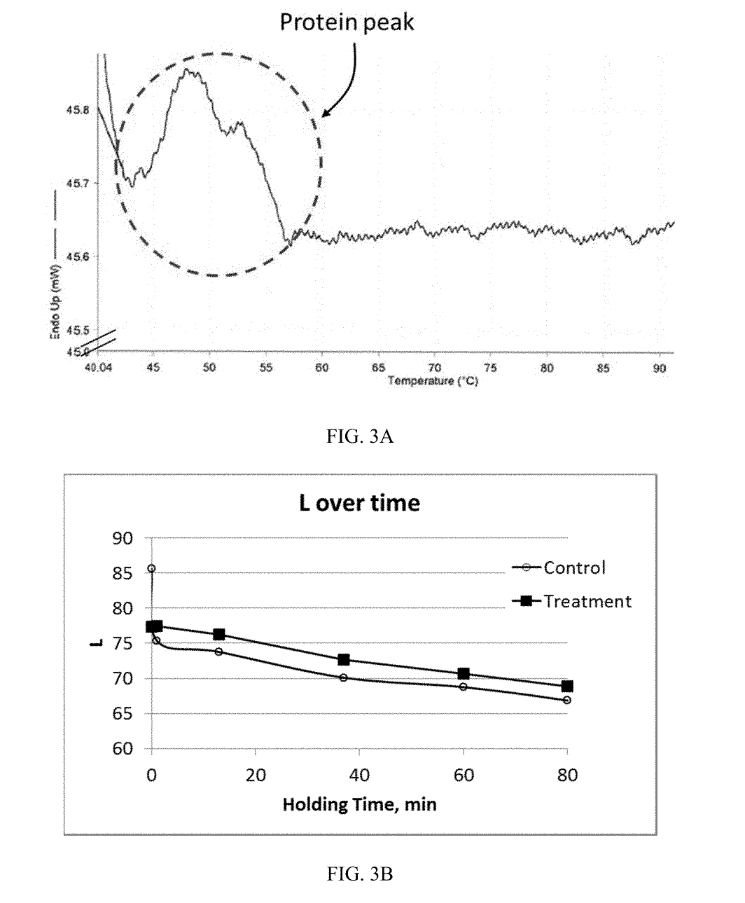

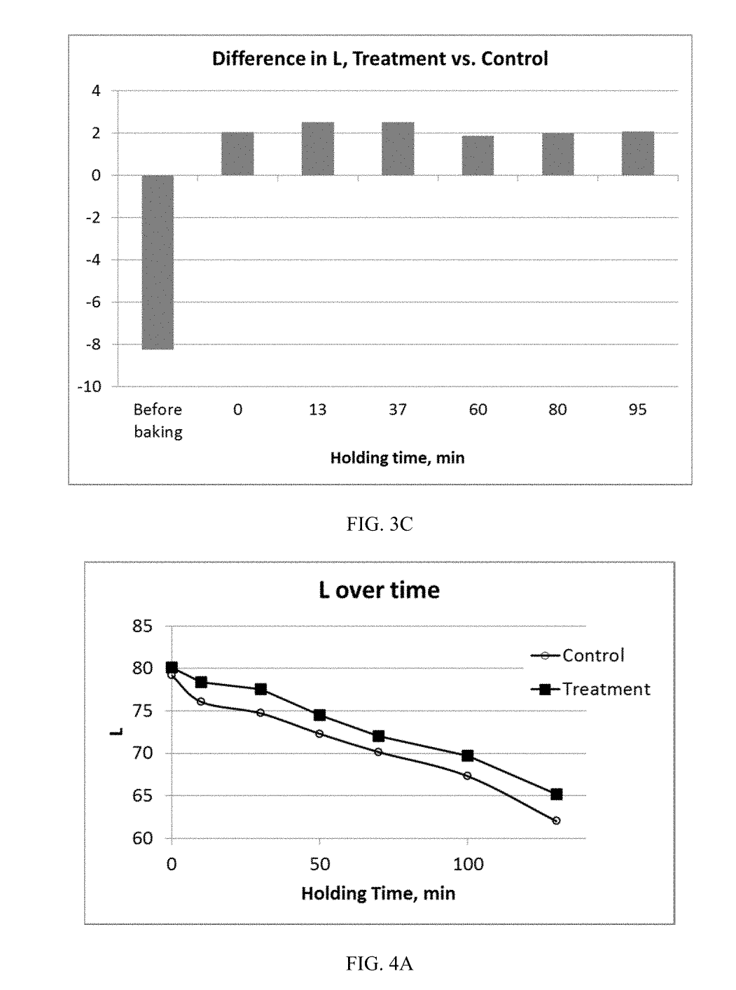

The chemical compositions of the samples are shown in TABLE 3. The thermogram of the treated cheese is shown in FIG. 3A. The control was similar to the control in Example 3, shown in the thermogram in FIG. 2A. Results of the testing are shown in TABLE 4 and graphically shown in FIGS. 3B and 3C.

TABLE 3
Chemical composition of control and treated cheese.

| Chemical Composition | Control | Treated Cheese |
|---|---|---|
| Moisture (%) | 47.5 | 48.1 |
| Total Ash (%) | 3.6 | 3.0 |
| Total Fat (%) | 25.1 | 23.5 |
| Total Protein (%) | 20.9 | 21.3 |
| Calcium (mg/100 g) | 645.0 | 648.0 |
| Sodium (%) | 0.7 | 0.5 |

TABLE 4
Color of treated cheese and control, averages of triplicate samples.

| | Control | | | | Treated Cheese | | | |
|---|---|---|---|---|---|---|---|---|
| Color | L | a | b | ΔE | L | a | b | ΔE |
| | Before baking | | | | | | | |
| | 85.62 | −1.70 | 18.70 | 20.28 | 77.38 | −4.80 | 18.53 | 25.68 |
| Holding Time | | | | | | | | |
| (min) | After Baking and During Holding | | | | | | | |
| 0 | 75.39 | −4.29 | 15.63 | 25.52 | 77.44 | −4.98 | 16.38 | 24.35 |
| 13 | 73.76 | −4.25 | 15.79 | 26.96 | 76.29 | −4.88 | 16.30 | 25.22 |
| 37 | 70.10 | −3.68 | 16.17 | 30.28 | 72.61 | −4.36 | 16.96 | 28.56 |
| 60 | 68.75 | −3.34 | 16.19 | 31.47 | 70.61 | −3.76 | 17.96 | 30.73 |
| 80 | 66.84 | −2.64 | 17.23 | 33.58 | 68.85 | −3.28 | 18.76 | 32.57 |
| 95 | 64.84 | −1.78 | 18.37 | 35.83 | 66.93 | −2.87 | 19.06 | 34.35 |

It was observed that at the beginning, the control cheese had a much higher whiteness (L value) than the treated cheese, but had lower whiteness value throughout the holding period of 95 min.

It was observed that the test cheese, which was prepared with gentler stretching and process conditions, had higher whiteness L value compared to the control. The L-value of the treated sample started out lower but was maintained throughout the holding period without a dramatic change as compared the control. The treated cheese was slightly more yellow (higher b-values) and a slightly more green (lower a-values). The lower ΔE of the treated cheese after holding was attributed to the higher amount of white. The treated cheese exhibited a higher protein peak in the thermogram than the control.

It was concluded that by modifying the process conditions during cheese making, some intact proteins in the cheese could be preserved, resulting in a longer cooked shelf life of the cheese.

### Example 5

The thermal properties and cooked shelf life of cheese treated with TiO₂ were studied and compared to a control. The treated cheese and the control were studied before and after baking and during holding at an elevated temperature. The color measurements were taken against a black background.

The treated sample of mozzarella cheese was prepared by adding 0.2% TiO₂ to the cheese curd during cheese making, before stretching. The control was regular mozzarella.

The cheeses were stored in a refrigerator and taken out to room temperature just before testing. The cheeses were shredded using a 4.5 mm shredder. Twenty three grams of each of the shredded cheeses were placed inside a 3.5 inch metal cylinder on a black metal tray. Color readings were taken for each cheese before baking.

The cheeses were baked in a preheated conventional oven at 450° F. for 2.5 min. The baked cheeses were then removed from the oven and transferred into a temperature-controlled cabin at 160° F. for a holding test to simulate food service display conditions. During the holding period, color readings were taken at 10-30 min intervals over a 130 min period.

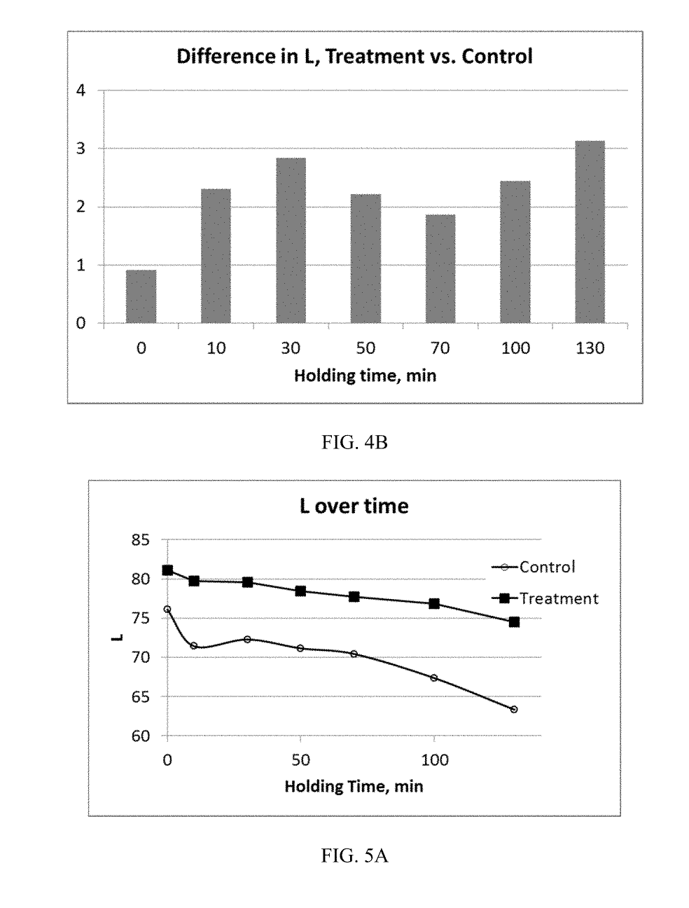

Results of the color readings are given in TABLE 5 and shown graphically in FIG. 4A. The difference in L-values is shown graphically in FIG. 4B.

It was observed that at the beginning, the control cheese had a similar whiteness value as the treated cheese (L value of 81.53 vs. 80.99, respectively). Both cheese samples had similar a and b values. However, the control cheese had lower whiteness value (L value) throughout the holding period of 130 min.

TABLE 5
Color of treated cheese and control, averages of triplicate samples.

| | | | | | Treated Cheese | | | |
|---|---|---|---|---|---|---|---|---|
| | Control | | | | with 0.2% TiO₂ | | | |
| Color | L | a | b | ΔE | L | a | b | ΔE |
| | Empty Pan | | | | | | | |
| | 27.92 | 0.37 | 0.47 | 69.11 | 27.11 | 0.87 | 0.49 | 69.92 |
| | Before baking | | | | | | | |
| | 81.53 | −5.34 | 18.04 | 22.40 | 80.99 | −5.20 | 17.51 | 22.36 |
| Holding Time | | | | | | | | |
| (min) | After Baking and During Holding | | | | | | | |
| 0 | 79.18 | −5.69 | 14.81 | 22.28 | 80.09 | −5.65 | 14.67 | 21.44 |
| 10 | 76.06 | −5.90 | 15.04 | 24.96 | 78.37 | −5.88 | 15.21 | 23.15 |
| 30 | 74.72 | −5.81 | 14.67 | 25.94 | 77.56 | −5.87 | 14.91 | 23.83 |
| 50 | 72.31 | −5.79 | 14.39 | 27.89 | 74.53 | −5.75 | 14.29 | 26.21 |
| 70 | 70.15 | −5.59 | 13.86 | 29.59 | 72.01 | −5.61 | 14.13 | 27.20 |
| 100 | 67.32 | −5.23 | 14.40 | 32.26 | 69.76 | −5.27 | 13.98 | 29.93 |
| 130 | 62.01 | −3.77 | 15.31 | 37.37 | 65.15 | −4.49 | 14.26 | 34.18 |

It was concluded that the treated cheese, which had a higher whiteness value, included an intact protein component. The lower ΔE of the treated cheese was attributed to the higher amount of white.

### Example 6

A cheese sample was prepared with gentler stretching conditions (without stretching or breakdown to the same extent as the control) during the cheese making process. The thermal properties and color changes before and after baking of the treated sample were tested and compared to a control of regular mozzarella cheese. The testing was performed as in Example 5. After the baking, the cheeses were observed to have spread about 0.5″.

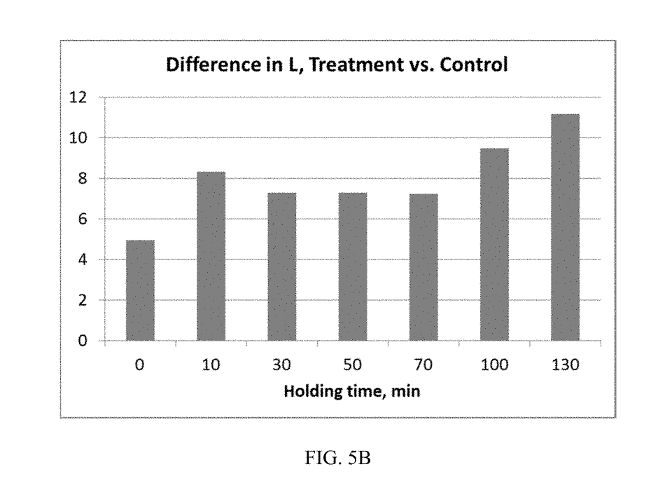

Results of the color testing are shown in TABLE 6 and graphically shown in FIGS. 5A and 5B.

TABLE 6
Color of cheese and control, averages of triplicate samples.

| | Control | | | | Cheese | | | |
|---|---|---|---|---|---|---|---|---|
| Color | L | a | b | ΔE | L | a | b | ΔE |
| | Empty Pan | | | | | | | |
| | 26.62 | 0.57 | 0.35 | 70.42 | 25.76 | 0.46 | 0.59 | 71.27 |
| | Before baking | | | | | | | |
| | 79.79 | −5.39 | 17.89 | 23.55 | 75.37 | −4.74 | 18.18 | 26.99 |
| Holding Time | | | | | | | | |
| (min) | After Baking and During Holding | | | | | | | |
| 0 | 76.10 | −6.16 | 15.94 | 25.45 | 81.06 | −5.86 | 17.64 | 22.57 |
| 10 | 71.42 | −6.14 | 15.38 | 29.00 | 79.75 | −6.01 | 17.96 | 23.76 |
| 30 | 72.28 | −6.10 | 15.03 | 28.25 | 79.58 | −6.08 | 18.21 | 24.06 |
| 50 | 71.15 | −6.03 | 14.69 | 29.08 | 78.44 | −6.16 | 17.96 | 24.73 |
| 70 | 70.43 | −5.96 | 14.41 | 29.57 | 77.68 | −6.26 | 18.03 | 22.07 |
| 100 | 67.36 | −5.62 | 13.46 | 32.01 | 76.84 | −6.29 | 18.14 | 26.08 |
| 130 | 63.33 | −5.16 | 12.96 | 35.56 | 74.50 | −6.37 | 18.02 | 27.91 |

It was observed that at the beginning, the control cheese was whiter than the treated cheese (L value of 79.79 vs. 75.37, respectively). The treated sample was slightly more yellow (higher b value), and slightly more red (higher a value). However, after baking, the treated sample had much higher whiteness value (L-value) immediately after baking and throughout the holding period. The lower whiteness of the control and the greater difference in whiteness on the black background as compared to a light-colored background in Example 4 was seen as evidence of greater translucency of the control. It was concluded that the treatment resulted in intact protein segments in the treated cheese and extended its warm shelf life.

While certain embodiments have been described, other embodiments may exist. While the specification includes a detailed description, the scope of the present disclosure is indicated by the following claims. The specific features and acts described above are disclosed as illustrative aspects and embodiments. Various other aspects, embodiments, modifications, and equivalents thereof which, after reading the description herein, may suggest themselves to one of ordinary skill in the art without departing from the spirit of the present disclosure or the scope of the claimed subject matter.

What is claimed is:

1. A cheese composition comprising:
at least 95% cheese;
about 18 to about 35% protein comprising about 0.01 to about 25% of intact protein segments by weight of the protein; and
about 0.001 to about 3% of an additive selected from titanium dioxide, calcium citrate, calcium sulfite, calcium sulfate, calcium caseinate, calcium propionate, potassium sorbate, potassium bitartrate, sodium caseinate, casein, whey protein, vegetable protein, and mixtures thereof.

2. A cheese composition made by:
preparing a cheese mass comprising cheese curds and whey;
straining the cheese mass to separate a cheese curd and whey;
mixing a stabilizing additive into the cheese curd; and
forming the cheese curd into the cheese composition,
wherein the cheese composition comprises about 18 to about 35% protein, and wherein the protein comprises about 0.01 to about 25% of intact protein segments by weight of the protein.

3. The cheese composition of claim 2, wherein the stabilizing additive comprises about 0.001 to about 3% of titanium dioxide, calcium citrate, calcium sulfite, calcium sulfate, calcium caseinate, calcium propionate, potassium sorbate, potassium bitartrate, sodium caseinate, casein, whey protein, vegetable protein, and mixtures thereof by weight of the cheese curd.

4. A pizza comprising:
a crust; and
cheese comprising about 18 to about 35% protein, wherein about 0.01 to about 25% of the protein is intact protein.

5. The pizza of claim 3, wherein the cheese further comprises about 0.001 to about 3% of an additive selected from titanium dioxide, calcium citrate, calcium sulfite, calcium sulfate, calcium caseinate, calcium propionate, potassium sorbate, potassium bitartrate, sodium caseinate, casein, whey protein, vegetable protein, and mixtures thereof.

6. A method for stabilizing cheese proteins, the method comprising:
preparing a cheese mass comprising cheese curds and whey;
adding a stabilizing additive to the cheese mass;
straining the cheese mass to separate a cheese curd and whey; and
forming the cheese curd into a cheese comprising about 18 to about 35% protein.

7. The method of claim 6, wherein the stabilizing additive comprises about 0.001 to about 3% of titanium dioxide, calcium citrate, calcium sulfite, calcium sulfate, calcium caseinate, calcium propionate, potassium sorbate, potassium bitartrate, sodium caseinate, casein, whey protein, vegetable protein, and mixtures thereof by weight of the cheese curd.

8. The method of claim 6, wherein the protein comprises about 0.01 to about 25% of intact protein segments by weight of the protein.

9. The method of claim 6, further comprising baking the cheese.

10. A method for making cheese, the method comprising:
preparing a cheese mass comprising cheese curds and whey;
straining the cheese mass to separate a cheese curd and whey;
heating the cheese curd to a temperature of about 100 to about 130° F. and stretching the cheese curd for about 10 to about 30 minutes without denaturing proteins in the cheese curd completely; and
forming the stretched cheese curd into a cheese comprising about 18 to about 35% protein, wherein the protein comprises about 0.01 to about 25% of intact protein segments by weight of the protein.

11. A baked pizza comprising:
a crust; and
cheese
wherein the color of the cheese on the baked pizza maintains a ΔL value of 10 units during the first 70 minutes following removal of the food product from either cooking or baking and held at a temperature of 160° F.

12. The pizza of claim 11, wherein the cheese comprises an additive selected from titanium dioxide, calcium citrate, calcium sulfite, calcium sulfate, calcium caseinate, calcium propionate, potassium sorbate, potassium bitartrate, sodium caseinate, casein, whey protein, vegetable protein, and mixtures thereof.

13. The pizza of claim 12, wherein the additive concentration in the pre-baked cheese is about 0.001 to about 3%.

14. The pizza of claim 11, wherein the pre-baked cheese comprises about 18 to about 35% protein, wherein about 0.01 to about 25% of the protein is intact protein.

15. The pizza of claim 11, wherein the baked pizza maintains a ΔL value of 5 units.

16. The pizza of claim 11, wherein the baked pizza maintains a ΔL value of 3 units.
